(19) United States
(12) Patent Application Publication
(10) Pub. No.: US 2021/0333112 A1
(43) Pub. Date: Oct. 28, 2021

(54) ROUTE SEARCH SYSTEM AND ROUTE SEARCH PROGRAM

(71) Applicants: AISIN AW CO., LTD., Anjo-shi, Aichi-ken (JP); TOYOTA JIDOSHA KABUSHIKI KAISHA, Toyota-shi, Aichi-ken (JP)

(72) Inventors: Katsuya MATSUNAGA, Nagoya, Aichi (JP); Koji UCHIYAMA, Okazaki, Aichi (JP); Xin JIN, Nagoya-shi, Aichi-ken (JP)

(73) Assignees: AISIN AW CO., LTD., Anjo-shi, Aichi-ken (JP); TOYOTA JIDOSHA KABUSHIKI KAISHA, Toyota-shi, Aichi-ken (JP)

(21) Appl. No.: 17/273,470

(22) PCT Filed: Sep. 18, 2019
(86) PCT No.: PCT/JP2019/036558

§ 371 Date: Mar. 4, 2021

(30) Foreign Application Priority Data
Oct. 12, 2018 (JP) 2018-193019

(51) Int. Cl. G01C 21/34; G01C 21/36

(52) U.S. Cl. CPC G01C 21/343; G01C 21/3461; G01C 21/3605

(57) ABSTRACT

To provide a technique for allowing a search for a route taking into account turnarounds in the entire way from a point of departure to a destination. A route search system includes a node obtaining part that obtains nodes present between a point of departure and a destination of a vehicle; a passage cost obtaining part that obtains a passage cost of a road section between the nodes and the passage costs of intersections represented by the nodes; and a route searching part that searches for a route with the smallest sum of the passage costs between the point of departure and the destination, and the route searching part sets the passage cost for a case of making a turnaround, for all of the intersections included in a candidate for a route from the point of departure to the destination, based on the road section traveled after the turnaround.

### CROSS REFERENCE TO RELATED APPLICATIONS

This application is a National Stage of International Application No. PCT/JP2019/036558 filed Sep. 18, 2019, claiming priority based on Japanese Patent Application No.2018-193019 filed Oct. 12, 2018, the contents of which are incorporated in their entirety.

### TECHNICAL FIELD

The present disclosure relates to a route search system and a route search program.

### BACKGROUND ART

Conventionally, there is known a technique for searching for a route traveled by a vehicle. For example, Patent Literature 1 discloses a technique in which when a vehicle goes off a guidance route, the vehicle is rerouted to the original guidance route.

### CITATIONS LIST

### Patent Literature

Patent Literature 1: JP 4970907 A

### SUMMARY OF THE DISCLOSURE

### Technical Problems

The above-described conventional technique discloses a configuration in which in order to take the vehicle back to a guidance route by allowing the vehicle to turn around at an intersection, intersections are sequentially set as determination targets in order from the closest one to the vehicle, and when an intersection matches a condition, a route is obtained that allows the vehicle to turn around at the intersection to take the vehicle back to the guidance route. Namely, in the conventional technique, it is assumed that when the vehicle goes off an existing guidance route, a route is searched that allows the vehicle to turn around at a nearby intersection to reroute the vehicle to the guidance route.

Aspects of the present disclosure are made in view of the above-described problem, and provide a technique that enables a search for a route taking into account turnarounds in the entire way from a point of departure to a destination.

### Solutions to Problems

To provide the above-described technique, a route search system includes a node obtaining part that obtains nodes present between a point of departure and a destination of a vehicle; a passage cost obtaining part that obtains a passage cost of a road section between the nodes and the passage costs of intersections represented by the nodes; and a route searching part that searches for a route with a smallest sum of the passage costs between the point of departure and the destination, and the route searching part sets the passage cost for a case of making a turnaround, for all of the intersections included in a candidate for a route from the point of departure to the destination, based on the road section traveled after the turnaround.

Namely, the route search system sets a passage cost for a case of making a turnaround, for all intersections included in a candidate for a route from a point of departure to a destination, based on a road section traveled after the turnaround. As a result, it becomes possible to search for a route taking into account turnarounds in the entire way from the point of departure to the destination.

### BRIEF DESCRIPTION OF DRAWINGS

FIG. 1 is a block diagram of a route search system.

FIG. 2A is a diagram showing a dual road, FIG. 2B is a diagram showing a single road, and FIG. 2C is a diagram showing an example of roads.

FIG. 3 is a flowchart showing a route search process.

### DESCRIPTION OF EMBODIMENTS

Here, an embodiment of the present disclosure will be described in the following order:

(1) Configuration of a route search system;

(2) Route search process; and

(3) Other embodiments.

### (1) Configuration of a Route Search System

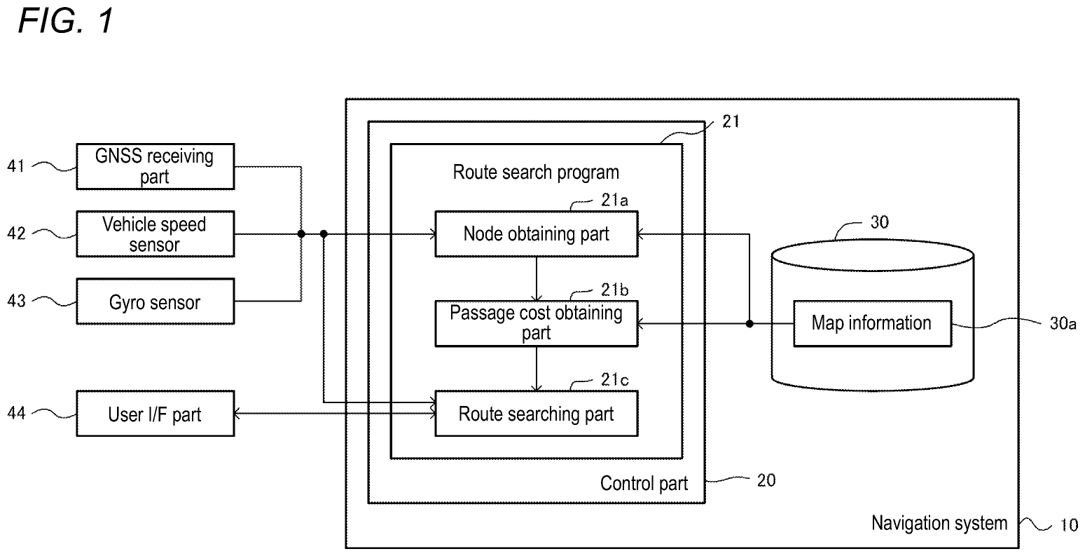

FIG. 1 is a block diagram showing a configuration of a navigation system 10 that functions as a route search system according to one embodiment of the present disclosure. The navigation system 10 is included in a vehicle and has a function of providing guidance on a vehicle's route. The navigation system 10 includes a control part 20 including a CPU, a RAM, a ROM, etc.; and a recording medium 30, and is connected to a GNSS receiving part 41, a vehicle speed sensor 42, a gyro sensor 43, and a user I/F part 44.

The GNSS receiving part 41 is a device that receives Global Navigation Satellite System signals, and receives radio waves from navigation satellites and outputs a signal for calculating a current location of the vehicle through an interface which is not shown. The control part 20 obtains the signal and thereby obtains a current location of the vehicle. The vehicle speed sensor 42 outputs a signal corresponding to the rotational speed of wheels provided on the vehicle. The control part 20 obtains the signal through an interface which is not shown, and thereby obtains vehicle speed. The gyro sensor 43 detects angular acceleration of the vehicle for a turn in a horizontal plane, and outputs a signal corresponding to the orientation of the vehicle. The control part 20 obtains the signal and thereby obtains a traveling direction of the vehicle. The vehicle speed sensor 42, the gyro sensor 43, and the like, are used to identify a travel path of the vehicle, and in the present embodiment, a current location is identified based on a point of departure and a travel path of the vehicle, and the current location of the vehicle identified based on the point of departure and the travel path is corrected based on an output signal from the GNSS receiving part 41.

The user I/F part 44 is an interface part for accepting, as input, instructions from a driver and providing various types of information to the driver, and includes a touch panel display, switches, etc., a speaker, etc., which are not shown. Namely, the user I/F part 44 includes an output part for images and audio; and an input part that accepts, as input, instructions from a user.

The recording medium 30 has map information 30a recorded therein in advance. The map information 30a includes, for example, shape interpolation point data representing, for example, the location of a node corresponding to an end point of a road section and the location of a shape interpolation point for identifying the shape of a road between nodes, link data representing a link between nodes, and facility data representing the location, name, attribute, etc., of a facility. Note that in the present embodiment the node data can include regulation information. For example, information indicating, for example, the regulation “no turnaround” or the regulation “no right turn” or “no left turn” at an intersection is associated with the node data.

In addition, the link data has information associated therewith, the information indicating the road type and number of lanes of a road section represented by the link data. Furthermore, information about a traveling direction on the road section is associated with the link data. In the present embodiment, the information indicating the traveling direction is defined in two types of modes. Namely, there are a mode in which the traveling directions of a two-way traffic road are represented by different links and a mode in which a two-way traffic road or a one-way traffic road is represented by a single link. In the present embodiment, the former is called a dual road and the latter is called a single road. Note that the two-way traffic road is a road where lanes with opposite traveling directions are present on the same road.

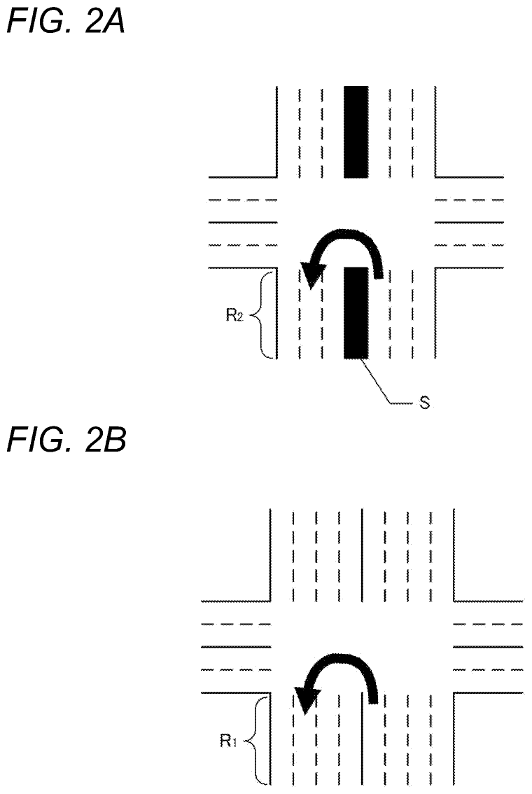

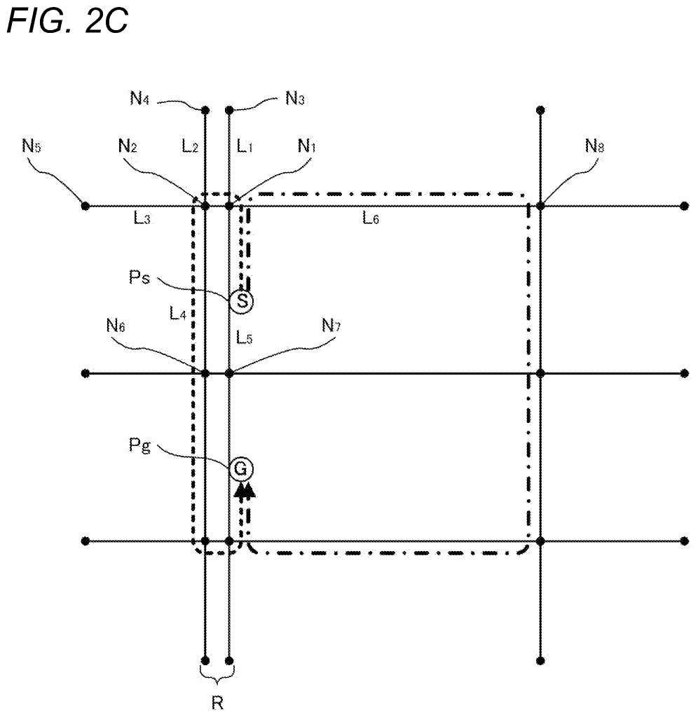

The dual road is, for example, a two-way traffic road such as a road R₂ shown in FIG. 2A, and is a road having a median strip in the middle thereof and having a relatively large number of lanes and a wide width. Therefore, when a road section is represented in the dual-road mode in the map information 30a, it can be considered that in the road section, the width of a road to be traveled after a turnaround is relatively wide and a turnaround is easy. Note that in roads shown in FIG. 2A, the road section R₂ is a dual road, but an intersecting road is not a dual road. Thus, a determination as to whether a road is a dual road is made based on roads passed before and after a turnaround at an intersection.

On the other hand, the single road is a two-way traffic road or a one-way traffic road. For example, a road section R₁ shown in FIG. 2B is a two-way traffic road, and has four lanes in each direction. Single roads include various roads other than such a road, and can include a road with a smaller number of lanes, a one-way traffic road, etc. Hence, when a road section is represented in the single-road mode in the map information 30a, a determination as to whether a turnaround is easy is made by the number of lanes of a road section traveled after the turnaround. Specifically, when the number of lanes of the road section traveled after the turnaround is greater than or equal to a threshold value (e.g., three lanes), it is considered that the turnaround is easy.

Furthermore, in the present embodiment, a facility represented by facility data can serve as a destination. In addition, the facility data has information associated therewith, the information indicating which side of a two-way traffic road a road section present along the facility is on. Namely, when a facility is present along a two-way traffic road, identification information of link data representing the two-way traffic road present along the facility is associated with facility data representing the facility. According to this configuration, when the facility is a destination, it is possible to identify which side of the two-way traffic road to be finally traveled on.

By a function of a navigation program which is not shown, the control part 20 accepts driver's input of a destination through the input part of the user I/F part 44, and searches for a route from a current location of the vehicle to the destination. In addition, by a function of the navigation program, the control part 20 can provide the driver of the vehicle with route guidance for guiding him/her to the destination while providing guidance on the route on a map, etc.

A guidance-target route is a route searched by the control part 20, and the navigation program includes a route search program 21 for performing a route search. In the present embodiment, the control part 20 performs a route search from a point of departure to a destination, using a predetermined algorithm (e.g., Dijkstra's algorithm) by the route search program 21.

The search is performed so as to obtain the smallest sum of passage costs of road sections and intersections included in a route. To implement such a search, in the present embodiment, the control part 20 obtains the passage costs of road sections and intersections in the course of a search process. Needless to say, the passage costs may be computed in advance before starting the search process and included in the map information 30a, etc.

In the present embodiment, a node represented by the map information 30a is an intersection, and a link indicates a road section between intersections. A passage cost corresponds to a value indicating the likelihood of being included in a route, and the smaller the value the higher the likelihood of being included in the route. The magnitude of a passage cost is a value corresponding to how easy to pass through a road section or an intersection, and may be determined by various elements. For example, the magnitude of a passage cost may be determined by the length of a road section, a required period, the level of congestion, etc. In the present embodiment, an example in which the passage cost of a road section is determined by distance is assumed. Namely, the value is set such that the longer the distance of the road section, the greater the value of the passage cost.

On the other hand, the passage cost of an intersection may also be determined by various elements indicating whether it is easy to pass through the intersection. For example, the passage cost of an intersection may be determined by a traveling direction, the number of lanes, the number of roads connected, etc. In the present embodiment, an example in which the passage cost of an intersection is determined by a traveling direction (exit direction) at the intersection is assumed. Namely, the value is set such that a cost for straight-ahead travel at the intersection <a cost for a left or right turn at the intersection <a cost for a turnaround at the intersection.

To search for a route based on such passage costs, the route search program 21 includes a node obtaining part 21a, a passage cost obtaining part 21b, and a route searching part 21c. The node obtaining part 21a is a program module that causes the control part 20 to perform a function of obtaining nodes present between a point of departure and a destination of the vehicle. Namely, by a function of the node obtaining part 21a, the control part 20 obtains, as candidate nodes, nodes representing intersections that can be included in a route after the point of departure, in the process of a search. In the present embodiment, after the point of departure, candidates for a route are sequentially set and the number of candidates for the route increases toward the destination. In this process, when a route with the smallest sum of passage costs is determined from among routes that can reach each node, the route is determined to be a route to a candidate node.

Candidate nodes are all nodes that can be reached from a given candidate, and nodes that can be candidate nodes may be limited so as to prevent an excessive increase in the amount of computation. For example, intersections that can be candidates or road sections that can be candidates may be limited. More specifically, it is possible to adopt, for example, a configuration in which intersections or road sections that belong to a mesh of the highest possible order serve as candidates.

The passage cost obtaining part 21b is a program module that causes the control part 20 to perform a function of obtaining a passage cost of a road section between nodes and a passage cost of an intersection represented by a node. Namely, when a road section has newly become a candidate as a result of obtaining a candidate node, the control part 20 obtains a passage cost of the road section. In the present embodiment, the passage cost is defined by the distance of a road section, and thus, the control part 20 identifies the locations of nodes which are end points of a road section by referring to the map information 30a, and obtains a distance of the road section based on the locations of both ends. Then, the control part 20 obtains a passage cost of the road section based on a predetermined passage cost per unit distance.

On the other hand, when a traveling direction at an intersection is identified by obtaining a candidate node, the control part 20 obtains a passage cost for the traveling direction at the intersection. Note that, in the present embodiment, the passage costs for a straight-ahead direction, a right-turn direction, and a left-turn direction are predetermined, and in a case of these directions, the control part 20 determines passage costs using predetermined values.

When a traveling direction at an intersection is a turnaround direction, the control part 20 determines a passage cost based on a road section traveled after a turnaround by referring to the map information 30a. Namely, when a road where a turnaround is made is a dual road, the control part 20 considers that a road section traveled after the turnaround has a width at which the turnaround is easy, and sets a passage cost to a value indicating that the turnaround is easy (e.g., a value equivalent to a preset distance (several hundred meters, etc.)). According to this configuration, the passage cost based on easiness of a turnaround can be set with a simple configuration.

When a road where a turnaround is made is a single road, the control part 20 obtains the number of lanes based on link data representing a road section traveled after the turnaround, by referring to the map information 30a. Then, when the number of lanes is greater than or equal to a threshold value, the control part 20 sets a passage cost to a value indicating that the turnaround is easy. When the number of lanes is less than the threshold value, the control part 20 sets a passage cost to a value indicating that the turnaround is impossible (in the present embodiment, ∞). Furthermore, when information indicating no turnaround is associated with node data represented by the map information 30a, a passage cost is set to a value indicating that a turnaround is impossible. According to this configuration, the passage cost based on easiness of a turnaround can be set.

The route searching part 21c is a program module that causes the control part 20 to perform a function of searching for a route with the smallest sum of passage costs between a point of departure and a destination. Namely, when the passage costs of road sections and nodes are obtained, the control part 20 obtains, for each route that can reach a candidate node, the sum of passage costs of an intersection and a road section included in the route. Then, when the sum of passage costs is obtained for all routes that are to be considered as routes that can reach the candidate node, a state in which a route with the smallest sum of passage costs to the candidate node has been identified is achieved. Hence, the control part 20 considers the route as a route to the candidate node. In the present embodiment, the control part 20 repeats such a process, and when a route with the smallest sum of passage costs is identified with a destination being a candidate node, the control part 20 obtains the route as a route from the point of departure to the destination.

Note that, in the present embodiment, the point of departure is a current location and the destination is a facility indicated by the map information 30a. Thus, upon performing a route search, the control part 20 obtains a current location of the vehicle based on output signals from the GNSS receiving part 41, the vehicle speed sensor 42, and the gyro sensor 43, and considers the current location as a point of departure. According to this configuration, an arbitrary location on a road section can be the point of departure. When the point of departure is obtained, the control part 20 performs a route search, considering the point of departure on the road section as the first node.

On the other hand, the destination is a facility indicated by the map information 30a, but in the present embodiment, the map information 30a does not include off-the-road information. Thus, a route to a point on a road closest to the destination can be searched, but a route for approaching the facility off the road cannot be searched. Hence, the control part 20 considers the closest location to the facility which is the destination on a road section present along the facility which is the destination, to be equivalent to the destination and searches for a route to the location.

The control part 20 searches for a route from the point of departure to the destination in the above-described manner. In this process, the control part 20 sets passage costs for a case of making a turnaround at all candidate nodes, based on a road section traveled after the turnaround. Namely, although a passage cost for a case of making a turnaround can be infinity depending on the regulation or the number of lanes, in the present embodiment, the configuration is not such that a turnaround is uniformly prohibited for all intersections or a turnaround is allowed for all intersections. For all intersections that have become candidates in the process of a search, the control part 20 computes and determines a cost for a turnaround.

According to the above-described configuration, a passage cost for a case of making a turnaround is set for all intersections included in a candidate for a route from a point of departure to a destination, based on a road section traveled after the turnaround. As a result, it becomes possible to search for a route that takes into account turnarounds in the entire way from the point of departure to the destination.

### (2) Route Search Process

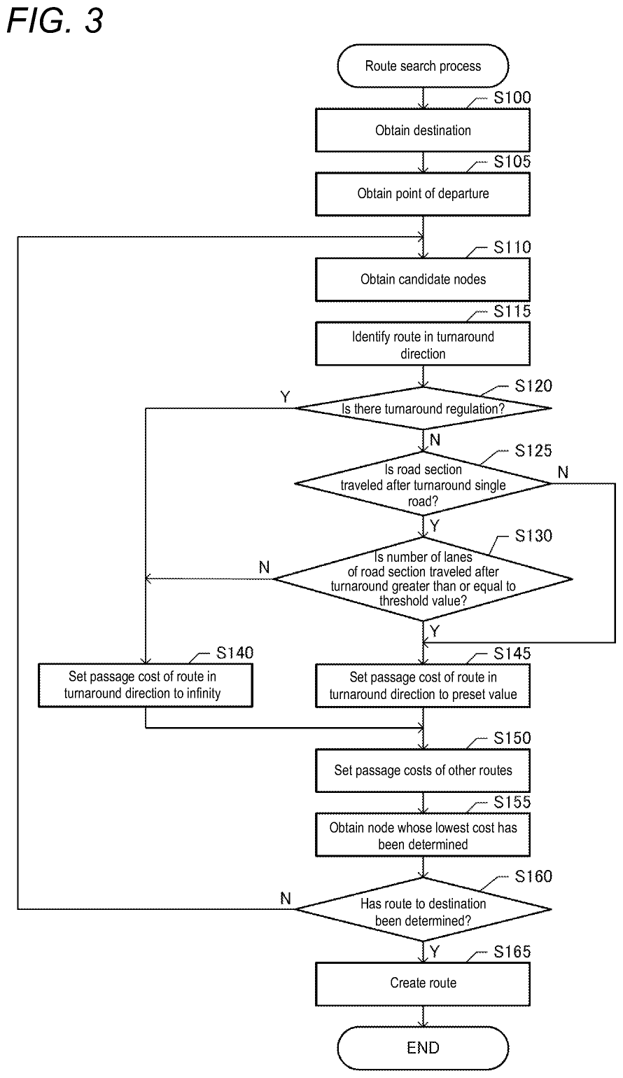

Next, a route search process for the vehicle will be described in detail based on a flowchart shown in FIG. 3. When the user instructs to start a route search process by operating the input part of the user I/F part 44, the control part 20 starts a route search process shown in FIG. 3. When the route search process starts, by the function of the route searching part 21c, the control part 20 obtains a destination (step S100). Namely, by the function of the route searching part 21c, the control part 20 accepts input of a destination. Specifically, the control part 20 controls the output part of the user I/F part 44 to display an interface for inputting a facility.

The user inputs a desired facility using the interface. Needless to say, various modes may be used to input a facility, and it is possible to adopt, for example, a configuration in which the user selects a facility from facility candidates retrieved based on the name, address, attribute, etc., of the facility, or a configuration in which the user specifies a facility displayed on a map.

When the facility is identified, the control part 20 identifies a road section present along the facility by referring to the map information 30a. When the road section present along the facility is a two-way traffic road, the control part 20 identifies which side of the two-way traffic road the road section present along the facility is on. Then, the control part 20 identifies the closest location to the facility on the road section present along the facility, and considers the location as a destination. The location is considered as a node. When the road section present along the facility is not a two-way traffic road, the road section present along the facility is one-way traffic. The control part 20 identifies the closest location to the facility on the one-way traffic road section, and considers the location as a destination.

FIG. 2C is a diagram schematically showing roads, and a node is represented by a black dot and a road section is represented by a solid line between black dots. Note that a road R extending in an up-down direction in FIG. 2C is a dual road. Thus, two lines lying side by side in the up-down direction with short spacing therebetween represent road sections in opposite traveling directions present on the same two-way traffic road. In FIG. 2C, a facility that is a destination is represented by reference sign G. In this example, the control part 20 performs a route search, considering a location Pg on the two-way traffic road that is closest to the facility, as a node serving as the destination.

Then, by the function of the route searching part 21c, the control part 20 obtains a point of departure (step S105). Namely, the control part 20 obtains a current location of the vehicle based on output signals from the GNSS receiving part 41, the vehicle speed sensor 42, and the gyro sensor 43, and considers the current location as a point of departure. In the example shown in FIG. 2C, a location Ps represented by reference sign S is a current location. Note that the example shown in FIG. 2C is an example of a country in which vehicles travel on the right side of the road. Thus, in the example shown in FIG. 2C, the destination is present behind the current location of the vehicle, and the vehicle cannot linearly travel to the destination in a rear direction in FIG. 2C from the road on which the current location is present.

Then, by the function of the node obtaining part 21a, the control part 20 obtains candidate nodes (step S110). In the present embodiment, adjacent nodes that can be reached from a node that is already a candidate serve as candidate nodes, and a process of obtaining passage costs based on the set candidate nodes, and identifying, for each candidate node, a route with the smallest sum of passage costs is repeated. In the process, a node included in a route at an initial stage of start of a route search is only the point of departure.

Thus, a node that is already a candidate at the initial stage is only the point of departure. Hence, when step S110 is performed for the first time, an adjacent node that can be reached from the point of departure is obtained as a candidate node. For example, in the example shown in FIG. 2C, since the vehicle can move only in a forward direction from the point of departure Ps, a node N₁ which is an adjacent node that can be reached from the point of departure Ps is obtained as a candidate node.

Note that in the present embodiment the map information 30a includes dual roads. In the present embodiment, a dual road is represented by pieces of link data representing respective sides of a two-way traffic road. Thus, at an intersection on the dual road, there can be two or more nodes representing the same intersection. For example, in the example shown in FIG. 2C, the road R is a dual road, and the nodes N₁ and N₂ represent the same intersection. In such a case, the nodes N₁ and N₂ are considered to be identical, and if the node N₁ serves as a candidate node, then the node N₂ also serves as a candidate node. Thus, in the example shown in FIG. 2C, if the node N₁ is initially obtained as a candidate node, then the node N₂ also serves as a candidate node.

On the other hand, if step S110 is performed when the point of departure Ps and the nodes N₁ and N₂ are already candidates, then the control part 20 obtains, as candidate nodes, nodes N₃, N₅, N₆, and N₈ which are adjacent nodes that can be reached from the nodes that are already candidates. Here, a route from the nodes N₁ and N₂ to the node N₆ corresponds to a route traveled when a turnaround is made at the intersection represented by the nodes N₁ and N₂. Namely, the control part 20 determines a passage cost for a case of making a turnaround, for all intersections included in a candidate for a route from the point of departure to the destination, and thus, obtains candidate nodes including also a turnaround direction.

Then, by the function of the passage cost obtaining part 21b, the control part 20 identifies a route in a turnaround direction (step S115). Namely, the control part 20 identifies a route in a turnaround direction from among routes that reach the candidate nodes newly obtained at step S110. For example, in the example shown in FIG. 2C, when the newly obtained candidate nodes are the nodes N₃, N₅, N₆, and N₈, a route from the nodes N₁ and N₂ to the node N₆ is identified as a route in a turnaround direction.

Then, by the function of the passage cost obtaining part 21b, the control part 20 determines whether there is a turnaround regulation (step S120). Namely, the control part 20 determines whether a turnaround on the route obtained at step S115 is prohibited by a regulation, by referring to the map information 30a. For example, in a case in which the route from the nodes N₁ and N₂ to the node N₆ shown in FIG. 2C is a determination target, when a turnaround from the nodes N₁ and N₂ to the node N₆ is prohibited at the intersection represented by the nodes N₁ and N₂, it is determined that there is a turnaround regulation. In addition, when a single road is a one-way traffic road and a travel direction after a turnaround is an opposite direction to that of the one-way traffic, it is determined that there is a turnaround regulation.

If it is determined at step S120 that there is a turnaround regulation, by the function of the passage cost obtaining part 21b, the control part 20 sets the passage cost of the route in the turnaround direction to infinity (step S140). Namely, if it is determined at step S120 that there is a turnaround regulation, a turnaround is to be prohibited. Hence, the control part 20 sets the passage cost of the route in the turnaround direction to infinity so that the route in the turnaround direction is not substantially selected as a route.

On the other hand, if it is not determined at step S120 that there is a turnaround regulation, by the function of the passage cost obtaining part 21b, the control part 20 determines whether a road section traveled after a turnaround is a single road (step S125). Namely, the control part 20 determines whether a road section traveled after a turnaround on the route obtained at step S115 is a single road, by referring to the map information 30a.

If it is not determined at step S125 that a road section traveled after a turnaround is a single road, i.e., if a road section traveled after a turnaround is a dual road, the control part 20 considers that the turnaround is easy. Then, the control part 20 sets the passage cost of the route in the turnaround direction to a preset value (step S145). Namely, the preset value is a predetermined value for a turnaround at an intersection, and is a value determined such that a route that makes a turnaround at an intersection can be searched. For example, the preset value may be determined such that the higher the level of difficulty in operation at an intersection, the greater the value. Such a value is greater than that of a passage cost for a left or right turn made at the same intersection, but is much smaller than infinity. For example, a value on the order of twice the value of a passage cost for a left or right turn at an intersection can be set as the preset value.

On the other hand, if it is determined at step S125 that a road section traveled after a turnaround is a single road, by the function of the passage cost obtaining part 21b, the control part 20 determines whether the number of lanes of the road section traveled after a turnaround is greater than or equal to a threshold value (step S130). Namely, when the road section traveled after a turnaround is a single road, the control part 20 obtains information indicating the number of lanes of the road section traveled after a turnaround, by referring to the map information 30a. Then, the control part 20 compares the number of lanes of the road section traveled after a turnaround with the predetermined threshold value.

If it is determined at step S130 that the number of lanes of the road section traveled after a turnaround is greater than or equal to the threshold value, by the function of the passage cost obtaining part 21b, the control part 20 sets the passage cost of the route in the turnaround direction to the preset value (step S145). Namely, in a situation in which a turnaround is easy because there is a large number of lanes of the road section traveled after the turnaround, the control part 20 sets the passage cost of an intersection such that a route that makes a turnaround at the intersection can be searched.

On the other hand, if it is not determined at step S130 that the number of lanes of the road section traveled after a turnaround is greater than or equal to the threshold value, by the function of the passage cost obtaining part 21b, the control part 20 sets the passage cost of the route in the turnaround direction to infinity (step S140). Namely, in a situation in which a turnaround is difficult because there is a small number of lanes of the road section traveled after the turnaround, the control part 20 sets the passage cost of an intersection such that a route that makes a turnaround at the intersection is not searched.

When the passage cost of the route in the turnaround direction (the passage cost for a case of making a turnaround at the intersection) is set in the above-described manner at step S140 or S145, by the function of the passage cost obtaining part 21b, the control part 20 sets passage costs of the other routes (step S150). Here, the other routes are routes that have newly become candidates as a result of newly obtaining candidate nodes at step S110, and that are different from the route in the turnaround direction identified at step S115. Such routes can include a route at an intersection and a route on a road section. The former includes operation at the intersection. For example, when a left turn is made at the intersection, a route in a left-turn direction at the intersection is considered as a route at the intersection.

For example, in the example shown in FIG. 2C, when the newly obtained candidate nodes are the nodes N₃, N₅, N₆, and N₈, the passage cost of the intersection represented by the nodes N₁ and N₂ is set based on a traveling direction at the intersection. Specifically, for a route traveled straight ahead at the intersection toward a road section L₁, the passage cost of the intersection is set to a value for straight-ahead travel. Likewise, for a route that makes a left turn at the intersection toward a road section L₃, the passage cost of the intersection is set to a value for a left turn, and for a route that makes a right turn at the intersection toward a road section L₆, the passage cost of the intersection is set to a value for a right turn.

In addition, for the route where the vehicle travels straight ahead at the intersection and travels on the road section L₁, the passage cost of the road section is set based on the distance of the road section L₁. For the route where the vehicle makes a left turn at the intersection and travels on the road section L₃, the passage cost of the road section is set based on the distance of the road section L₃, and for the route where the vehicle makes a right turn at the intersection and travels on the road section L₆, the passage cost of the road section is set based on the distance of the road section L₆. For the route where the vehicle turns around at the intersection and travels on a road section L₄, the passage cost of the road section is set based on the distance of the road section L₄.

When step S150 is performed, a state in which the passage costs of an intersection and a road section have been identified for each of the routes that have newly become candidates as a result of newly obtaining candidate nodes at step S110 is achieved. Hence, by the function of the route searching part 21c, the control part 20 obtains a node whose lowest cost has been determined (step S155). Namely, when the passage costs of an intersection and a road section have been identified for all routes that can reach a candidate node from the point of departure, the control part 20 considers the candidate node as a node whose lowest cost has been determined, and thereafter considers the candidate node as a node whose route has been determined instead of as the candidate node. Note that for a node whose route has been determined, the control part 20 obtains, for each route that can reach the node from the point of departure, the sum of passage costs of an intersection and a road section included in the route. Then, the control part 20 considers a route with the smallest sum as a route to the node.

Then, by the function of the route searching part 21c, the control part 20 determines whether a route to the destination has been determined (step S160). Namely, when the lowest cost of the node that is considered as a destination in the process at step S100 has been determined, the control part 20 determines that a route to the destination has been determined. If it is not determined at step S160 that a route to the destination has been determined, the control part 20 repeats the processes at and after step S110.

On the other hand, if it is determined at step S160 that a route to the destination has been determined, by the function of the route searching part 21c, the control part 20 creates a route to the destination (step S165). Namely, for the determined route, the control part 20 generates information indicating road sections and intersections from the point of departure to the destination in order of passage, and records the information as route information in the RAM, etc. When the route is created in the above-described manner, by the function of the navigation program, the control part 20 provides guidance on the route.

According to the above-described configuration, a route can be searched such that a turnaround at an intersection where the turnaround is easy is allowed. Thus, in the example shown in FIG. 2C, upon searching for a route from the current location S of the vehicle to the destination G, a route that reaches the destination G with short-distance travel by repeating a turnaround as indicated by a dashed line can be searched.

When a turnaround is not allowed, for example, a route as indicated by a dash-dotted line is obtained that reaches the destination G by making a right turn at the intersection (the nodes N₁ and N₂) closest to the point of departure S and repeating a right turn at intersections. In this case, the distance to the destination G is excessively long compared to the dashed-line route. However, in the present embodiment, since a turnaround is allowed for not only the closest intersection but also the entire route from the point of departure S to the destination G, it is possible to search for a route that is efficiently travelled to the destination G by making a plurality of turnarounds.

### (3) Other Embodiments

The above-described embodiment is an example for carrying out the various aspects of the present disclosure, and various types of modes can be adopted as long as a passage cost for a case of making a turnaround is set for all intersections included in a candidate for a route from a point of departure to a destination. For example, the navigation system 10 may be included in the vehicle or may be a portable terminal, etc. Furthermore, the system shown in FIG. 1 may be made up of a larger number of systems. For example, one of the functions of the navigation system 10 (the function of obtaining passage costs, etc.) may be implemented by another system such as a server.

In addition, at least one of the parts (the node obtaining part 21a, the passage cost obtaining part 21b, and the route searching part 21c) included in the navigation system 10 may be present separated into a plurality of devices. For example, a function of obtaining a current location of the vehicle based on signals from the GNSS receiving part 41, etc., may be implemented by an ECU, etc., other than the control part 20. In addition, a configuration in which some of the configurations of the above-described embodiment are omitted or a configuration in which a process is changed or omitted can also be assumed.

The node obtaining part may be configured in any manner as long as the node obtaining part can obtain nodes present between a point of departure and a destination of the vehicle. Namely, in a configuration in which a route is searched for based on a road network represented by nodes and road sections (links), the node obtaining part may be configured in any manner as long as the node obtaining part can obtain a candidate for a route that is a cost evaluation target, by selecting nodes present between the point of departure and the destination. Note that selection of nodes corresponding to both ends of a road section is equivalent to selection of the road section, and thus, obtaining of nodes may be considered to be obtaining of a road section.

The point of departure of the vehicle may be a current location of the vehicle or may be a point specified as a starting point of a route search (e.g., a driver's home or a driver's place of employment). The destination may be any point where the vehicle is scheduled to visit, and a configuration may be adopted in which not only a final destination but also a stopover location is considered as a destination. A node may be any end point of a road section, and a configuration in which a point other than an intersection is a node may be adopted.

The passage cost obtaining part may be configured in any manner as long as the passage cost obtaining part can obtain a passage cost of a road section between nodes and a passage cost of an intersection represented by a node. Namely, when a candidate for a route is identified as a result of obtaining a node, the passage cost obtaining part only has to obtain, for each of a road section and an intersection, a passage cost of the newly added candidate for a route. Note that the passage cost obtaining part obtains a passage cost for each of a road section and a node.

Upon obtaining the passage costs, the passage cost obtaining part obtains a passage cost for all intersections included in a candidate for a route from a point of departure to a destination. Namely, instead of taking into no account a turnaround at an intersection, a passage cost of each intersection for a case of making a turnaround is set for all intersections. Note, however, that a passage cost for a turnaround is a passage cost for a case of making a turnaround.

Thus, a configuration is not included in which passage costs for all intersections are set to be very high (infinity, a number two or more places greater, etc.) compared to other passage costs (e.g., left/right turn costs). Namely, a state in which a turnaround is prohibited at substantially all intersections by passage costs is not a state in which a passage cost for a case of making a turnaround is set for all intersections.

Needless to say, since the passage cost of an intersection is set based on a road section traveled after a turnaround, the passage cost of an intersection where a road section traveled after a turnaround is narrow can be very higher than the passage costs of other intersections. In addition, the passage cost of an intersection based on, for example, one-way traffic or the size of a crossing road can be very higher than the passage costs of other intersections. When the passage cost of an intersection is thus much higher than the passage costs of other intersections, a state in which a turnaround at the intersection is substantially prohibited is achieved, but a state in which a turnaround is prohibited at substantially all intersections is not achieved. Namely, unless there is a reason that a turnaround cannot be made, for all intersections, a passage cost based on a road section traveled after a turnaround is set, and a passage cost of a magnitude that makes a turnaround an option is set.

Note that for the passage cost of an intersection, costs other than a cost for a turnaround may be set, and the passage cost of an intersection may be determined by various techniques, e.g., a cost for a left or right turn or straight-ahead travel, the size or curve angle of the intersection, and the number of roads connected to the intersection. Needless to say, the passage cost of a road section may also be determined by various techniques, and may be determined by various elements such as the number of lanes, the level of congestion, or the road type, in addition to the above-described value based on the distance. Needless to say, the passage costs of a plurality of elements may be compositely (e.g., linear combination) included in a calculation, or an element of a passage cost on which importance is placed may be variable (e.g., distance is prioritized or a general road is prioritized).

A state in which a passage cost for a case of making a turnaround is set for all intersections included in a candidate for a route from a point of departure to a destination only has to be a state other than a state in which a turnaround is allowed for only some of the intersections (e.g., only an intersection present ahead in a vehicle's traveling direction). Namely, there can be an intersection whose passage cost is high for a reason that a road traveled after a turnaround is narrow, etc., but a search is to be performed, with an evaluation as to whether a turnaround can be made in all sections from a point of departure to a destination being made.

The route searching part may be configured in any manner as long as the route searching part can search for a route with the smallest sum of passage costs between a point of departure and a destination. Namely, a route is to be searched based on the passage costs of road sections and the passage costs of intersections. The search may be performed by various techniques, and for example, Dijkstra's algorithm or A* algorithm or modified versions of those algorithms can be adopted. The route with the smallest sum of passage costs is a route searched such that the value of a passage cost is defined to be smaller for easier passage of a road section or an intersection. Thus, when the passage cost is defined such that the easier it is to pass through a road section or an intersection, the greater the value of the passage cost, a route with the largest sum of passage costs is searched, but both routes are substantially equivalent to each other.

A road section present along a facility is a road section from which the vehicle can enter the facility directly (without crossing a road) when the user visits the facility, or a road section from which the vehicle can approach the nearest point to the facility. Thus, when the nearest road to the facility is a two-way traffic road, a road section closer to the facility is a road section present along the facility. Note that, in the above-described embodiment, the configuration is such that when a facility is a destination, a route to the closest location to the facility which is the destination on a road section present along the facility is searched, but needless to say, when a road section for approaching the facility or a road section within the facility is defined, a route including these road sections may be searched for.

Furthermore, for a technique for determining a passage cost, various configurations other than that in the above-described embodiment may be adopted. For example, a passage cost for a case of making a turnaround may vary from area to area. The passage cost may have any value for each area, and an area in which a turnaround is substantially prohibited or an area in which a turnaround is allowed may be provided. For example, when there is a no turnaround area, information indicating the no turnaround area is recorded in the map information 30a.

Then, by the function of the passage cost obtaining part 21b, the control part 20 determines whether a candidate node is present in a no turnaround area, by referring to the map information 30a. When the candidate node is an intersection present in a no turnaround area, the control part 20 sets a passage cost for a case of making a turnaround at the intersection to a value indicating that passage is impossible. According to the above-described configuration, a cost for no turnaround can be easily set.

Furthermore, a technique for setting a passage cost for a case of making a turnaround, for all intersections included in a candidate for a route from a point of departure to a destination as in the present disclosure is also applicable as a program or a method. In addition, a system, a program, and a method such as those described above may be implemented as a single device or may be implemented using a component shared with each part included in the vehicle, and include various types of modes. For example, it is possible to provide a method or program implemented by a system such as that described above. In addition, changes can be made as appropriate, e.g., a part is software and a part is hardware. Furthermore, the aspects of the present disclosure are also feasible as a recording medium for a program that controls a device. Needless to say, the recording medium for software may be a magnetic recording medium or may be a semiconductor memory, and any recording medium to be developed in the future can also be considered exactly in the same manner.

### REFERENCE SIGNS LIST

10: Navigation system, 20: Control part, 21: Route search program, 21a: Node obtaining part, 21b: Passage cost obtaining part, 21c: Route searching part, 30: Recording medium, 30a: Map information, 41: GNSS receiving part, 42: Vehicle speed sensor, 43: Gyro sensor, and 44: User I/F part

1. A route search system comprising:
a node obtaining part that obtains nodes present between a point of departure and a destination of a vehicle;
a passage cost obtaining part that obtains a passage cost of a road section between the nodes and the passage costs of intersections represented by the nodes; and
a route searching part that searches for a route with a smallest sum of the passage costs between the point of departure and the destination,
wherein
the route searching part sets the passage cost for a case of making a turnaround, for all of the intersections included in a candidate for a route from the point of departure to the destination, based on the road section traveled after the turnaround.

2. The route search system according to claim 1, wherein
information is associated with a facility that can serve as the destination, the information indicating which side of a two-way traffic road the road section present along the facility is on, and
the route searching part searches for a route from the point of departure to a closest location to the facility on the road section present along the facility, the facility being the destination.

3. The route search system according to claim 1, wherein
the passage cost for a case of making a turnaround has:
a value indicating that passage is possible, when a number of lanes present on the road section traveled after the turnaround is greater than or equal to a threshold value; and
a value indicating that passage is impossible, when the number of lanes present on the road section traveled after the turnaround is less than a threshold value.

4. The route search system according to claim 1, wherein when the road sections traveled before and after a turnaround are a two-way traffic road, the passage cost for a case of making a turnaround has a value indicating that passage is possible.

5. The route search system according to claim 1, wherein the passage cost for a case of making a turnaround at the intersection present in a no turnaround area has a value indicating that passage is impossible.

6. A route search program stored on a non-transitory computer readable medium that causes a computer to function as:
a node obtaining part that obtains nodes present between a point of departure and a destination of a vehicle;
a passage cost obtaining part that obtains a passage cost of a road section between the nodes and the passage costs of intersections represented by the nodes; and
a route searching part that searches for a route with a smallest sum of the passage costs between the point of departure and the destination,
wherein
the route searching part causes a computer to perform a function of setting the passage cost for a case of making a turnaround, for all of the intersections included in a candidate for a route from the point of departure to the destination, based on the road section traveled after the turnaround.
